(19) United States
(12) Patent Application Publication
(10) Pub. No.: US 2005/0246094 A1
(43) Pub. Date: Nov. 3, 2005

(54) Smart space RFID system and method

(76) Inventor: Richard Moscatiello, Decatur, GA (US)

Correspondence Address: NEEDLE & ROSENBERG, P.C., SUITE 1000, 999 PEACHTREE STREET, ATLANTA, GA, 30309-3915, US

(21) Appl. No.: 11/111,349

(22) Filed: Apr. 21, 2005

Related U.S. Application Data
(63) Continuation-in-part of application No. 10/906,301, filed on Feb. 14, 2005.
(60) Provisional application No. 60/566,349, filed on Apr. 30, 2004.

(51) Int. Cl. G01C 21/26

(52) U.S. Cl. 701/207; 340/539.13; 340/825.49; 340/10.1

(57) ABSTRACT

A radio frequency identification (RFID) system and method are provided for enabling a mobile radio transceiver to establish the location of moveable objects in a finite space, such as a building or campus, by identifying passive RFID transponders placed on the moveable objects, and correlating the objects with passive RFID transponders placed at fixed positions in the finite space.

### CROSS-REFERENCE TO RELATED PATENT APPLICATIONS

This application claims priority under 35 U.S.C. §119 to U.S. Provisional Patent Application Ser. No. 60/566,349, entitled “Smart Space RFID Systems,” filed on Apr. 21, 2004. This application is also a continuation-in-part of U.S. patent application Ser. No. 10/906,301, entitled “WIRELESS MOBILE ASSET TRACKING VEHICLE,” filed on Feb. 14, 2005, for which priority is claimed.

### TECHNICAL FIELD OF THE INVENTION

The present invention relates generally to transponder/reader systems for the tracking of transponder-tagged objects and spaces and, and in one embodiment, to a radio frequency identification (RFID) transponder/vehicle-mounted reader system for the detection and identification of moveable objects distributed within a building or structural space and for the storage, transmission, and reporting of information related to the transponder-tagged object.

### BACKGROUND

Organizations such as hospitals, manufacturing plants, and professional offices use portable objects such as medical equipment, tools, and physical documents that are distributed within the organization's operating environment such as a building, factory, or office complex (i.e., a structural space). Originating from a central distribution point, the moveable object is delivered to a specified location in the structural space. However, as a function of its use, the moveable object may travel to various different locations in the structural space, for example to a different wing of a hospital. Once the user has completed using the moveable object, that object becomes available for use elsewhere within the organization's facility. However, the uncertainty of the moveable object's last location makes it difficult to retrieve for redistribution. The result is a high cost of managing the organization's inventory of portable objects. For example, it is time-consuming, labor-intensive, and inefficient to locate portable equipment by manually searching large buildings and structural spaces. Also, in order to meet time-critical demand, extra objects may need to be rented from outside suppliers, further increasing cost. Thus, a need exists for an effective system for tracking portable objects within a structural space at low cost.

There are various prior art methods for managing the location of moveable objects within a structural space using RFID technology. These methods utilize fixed transceivers to generate a modulated radio frequency source which is transmitted via an antenna. The fixed transceiver is referred to as an interrogator. These systems also utilize a small portable transponder tuned to a modulated radio frequency, which is attached to the object and which gathers energy from the transmitted carrier wave. The energy gathered by the transponder causes it to emit a modulated radio frequency reply transmission which can be received by the interrogator. The reply transmission includes a unique identifier and may also include data about the object, allowing the fixed transponders to collect data about the moveable object, such as last known location and time.

One method, illustrated in FIG. 2, known generically as the portal method, uses a grid of many RFID interrogators and antennae by positioning them in fixed locations within the structural space. Tagged objects that pass within the range of a fixed interrogator are identified and time-stamped as having been seen at that location. This method is impractical because of the high cost of individual RFID interrogators and antennae and the cost of installing coaxial cabling to the antennae in a large structural space. Increasing positional accuracy requires the addition of more RFID interrogators.

Another method, illustrated in FIG. 3, known generically as the triangulation method, uses RFID interrogators with at least two directional antennae that are positioned on the outer boundaries of a structural space. Moveable objects fitted with active (i.e., battery powered) RFID transponders are then detected and located within the structural space using radio frequency (RF) triangulation techniques. In order for the RF to penetrate obstructions such as walls and structural elements, the RF is preferably in the approximate range of 300 MHz to 500 MHz. However, current RFID industry standards in development for supply chain and asset management applications identify the 902 MHz to 928 MHz band as ideal. Although the active transponders have a longer RF detection range, they are not as small and inconspicuous as passive transponders, are more expensive, and require maintenance.

Another method known in the art for tracking objects is the Global Positioning System (GPS). A GPS system uses several satellites in space to triangulate an object's position on the ground. However, GPS signals do not penetrate structures well, preventing it from being a viable solution for tracking moveable objects in a structural space.

Accordingly, there is a need for an RFID system and method in which object transponders and mobile interrogators are hosted by a “smart environment” whose location information and mapping are programmed into the space itself. There is also need for a system which does not rely on costly fixed interrogators or active transponders to locate transponder-tagged objects in a finite space.

### SUMMARY

The present invention is directed to a system and method of using transponder tags and one or more fixed or mobile interrogators for detecting, identifying, and locating portable objects in a structural space with respect to time. The term radio frequency (RF) includes in one embodiment a tuned, oscillating field of electromagnetic radiation. Radio Frequency Identification (RFID) includes in one embodiment a method of acquiring data over a modulated electromagnetic field carrier wave, tuned to a specified band of frequencies, by imparting a reflection of the source field radiation back to the transmitter in sequences that are interpreted as information in the form of digital data. Interrogator includes in one embodiment an electronic instrument that generates modulated radio frequencies for transmitting and receiving RFID data. A RFID tag (also called RFID tag, transponder tag, tag) is a miniaturized electrical assembly in one embodiment comprising an integrated circuit (IC) chip mated to a small antenna, the purpose of which is to communicate digital data stored in the IC chip to a RFID interrogator. An active RFID tag in one embodiment is a RFID transponder powered by a battery or other power source. A passive RFID tag in one embodiment is a RFID transponder powered by energy drawn from the RF carrier wave transmitted by the interrogator. An object or location is tagged when it has a RFID transponder affixed. A space, smart space, finite space, or structural space includes a two-dimensional area or three-dimensional volume having fixed boundaries defined by fences, walls, ceilings, floors, floor plans, rooms, entry and exit points, pathways, cubicles, grids, pillars, or other physical or structural elements. Examples include, but are not limited to, hospitals, multi-story buildings, factories, campuses, habitable areas, warehouses, office complexes, etc. A mobile interrogator in one embodiment includes a mobile device or conveyance that has been fitted with an RFID interrogator, and optionally including at least one antenna, a computer data processor, and a rechargeable power source, wherein the mobile interrogator is capable of detecting and identifying RFID transponders in a structural space. The mobile interrogator may also include a radio modem for wireless data communication. A time-stamp in one embodiment includes a relative record of the current real time that a tag is detected, including data such as year, month, day, hour, minute, second, or fractional-second. A storage device in one embodiment includes volatile and non-volatile forms of storage, including random access memories, cache memories, processor registers, hard disk drives, flash memories, tape storage devices, optical disks, floppy disks, and databases. These terms may be used differently in one or more embodiments and are not intended to limit the scope of the present system and method, wherein other meanings operable in various embodiments will be readily apparent to those skilled in the art.

In one embodiment, the present invention uses passive RFID transponder tags attached to moveable objects with a vehicle-mounted reader for the detection, identification, and location of moveable objects in a structural space with respect to time. Active RFID tags may also be used in the many embodiments of the present invention. A matrix of location identifiers in the form of passive RFID transponders or tags is created, wherein each tag identifies a particular location in a finite space. A community of mobile and stationary wireless or wired interrogators read tags within proximity or read range of the interrogators, allowing the location of tagged objects to be determined in relation to a matrix of transponders at fixed positions in the finite space. Location in one embodiment is accomplished in two stages as needed, first by proximity to the matrix, then by establishing bearings to embedded tags with respect to the interrogator. Location of objects adjacent to the interrogator follows similar steps, first they are located in a general area by proximity and read range, and then they may be more precisely located by direction finding. Tag information in one embodiment representing a fixed point in the structural space as well as proximity time or timestamp may be communicated wired or wirelessly to a server system for storage, analysis, display, and other functions.

The present invention is further directed to a system and method of object identification which provides detailed information pertaining to the tagged portable object or tagged fixed location. The present invention is further directed to a method for the management of an inventory of portable objects within a structural space. Thus, the present invention provides a system of passive or active RFID transponder tags and a vehicle-mounted RFID interrogator for detecting, identifying, and locating portable objects within a finite space or structural space with respect to time.

These and other aspects of the present invention will become apparent to those skilled in the art after a reading of the following description of the several embodiments when considered with the drawings.

### BRIEF DESCRIPTION OF THE DRAWINGS

Reference will now be made to one or more embodiments of the present invention which are depicted in the drawings. Each embodiment depicted in the drawings is provided for explanation of the invention and is not meant as a limitation of the invention. It is intended that the present invention includes the depicted embodiments as well as combinations and modifications of the depicted and other embodiments. The drawings, together with the description, serve to explain by way of non-limiting examples the principles of the invention.

FIG. 1 is an illustration of one embodiment of a basic RFID system.

FIG. 2 is an illustration of the prior art portal method of locating RFID tagged objects.

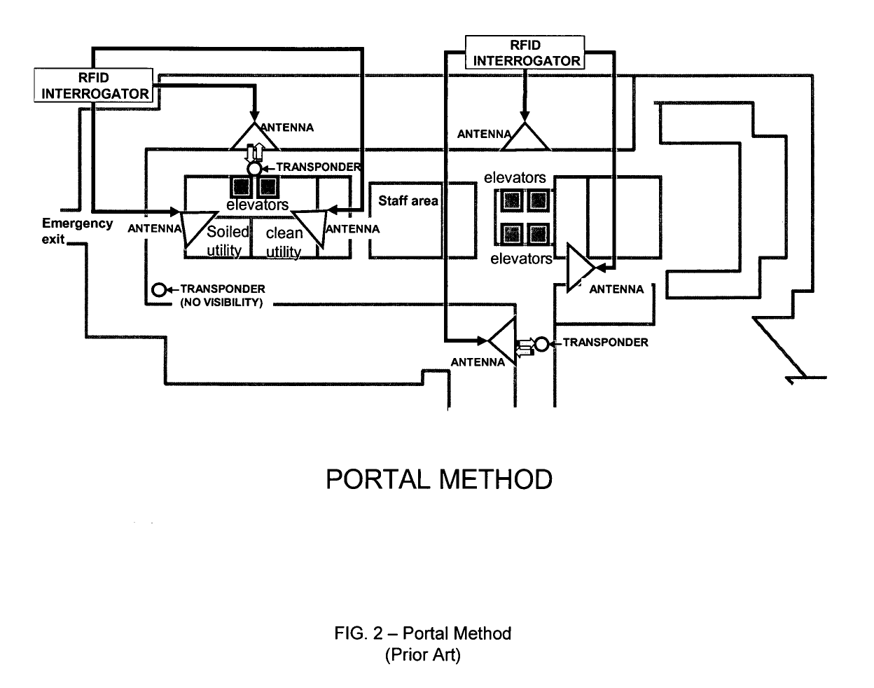

FIG. 3 is an illustration of the prior art triangulation method of locating RFID tagged objects.

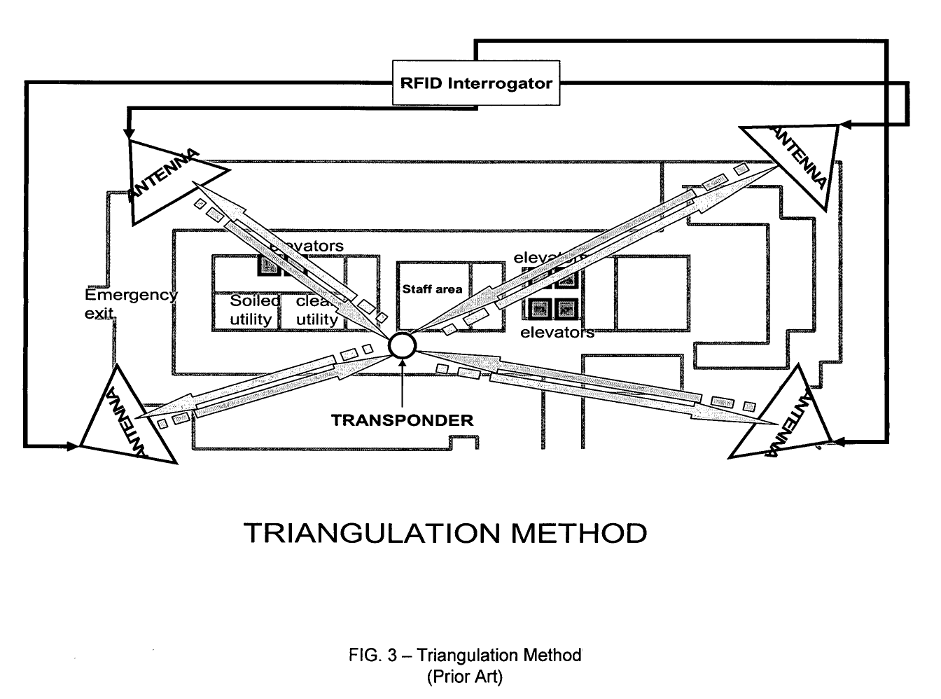

FIG. 4 is an illustration of one embodiment of the smart space model overview.

FIG. 5 is an illustration of one embodiment of the logical view of a mobile RFID interrogator.

FIG. 6 is an illustration of one embodiment of a detailed view of a mobile RFID interrogator.

FIG. 7 is an illustration of one embodiment of a mobile RFID interrogator in operation.

FIG. 8 is an illustration of one embodiment of the RFID object identification method.

FIG. 9 is an illustration of one embodiment of the RFID object identification method.

### DETAILED DESCRIPTION

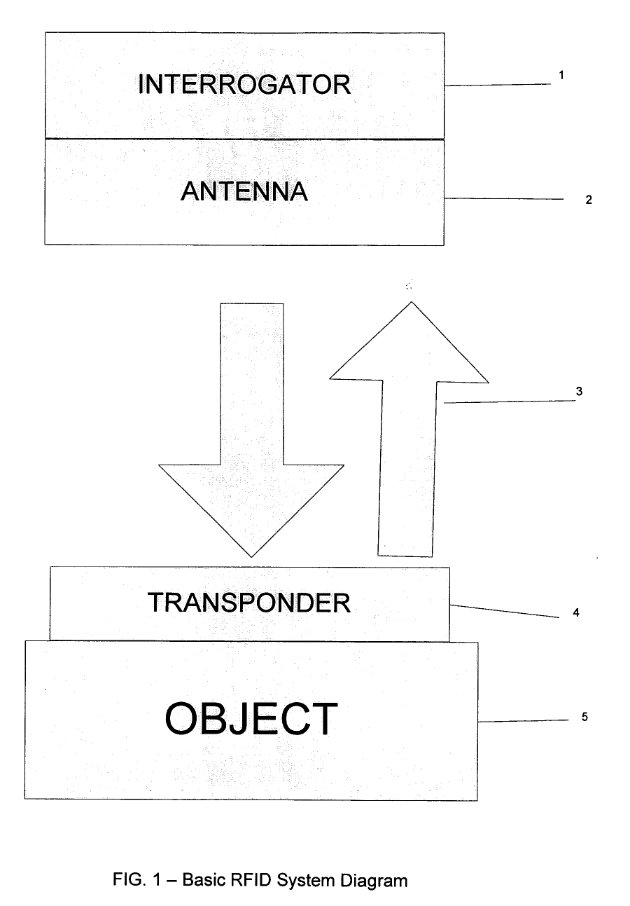

A basic logical overview of the system and method of the present invention is depicted in FIG. 1. One embodiment of the system and method includes a RFID interrogator 1 and an antenna 2 for transmitting RFID interrogation broadcasts and receiving RFID identifier responses 3. A RFID transponder 4 is attached to a moveable object 5, allowing the interrogator 1 of one embodiment to locate the moveable object 5 in a structural space.

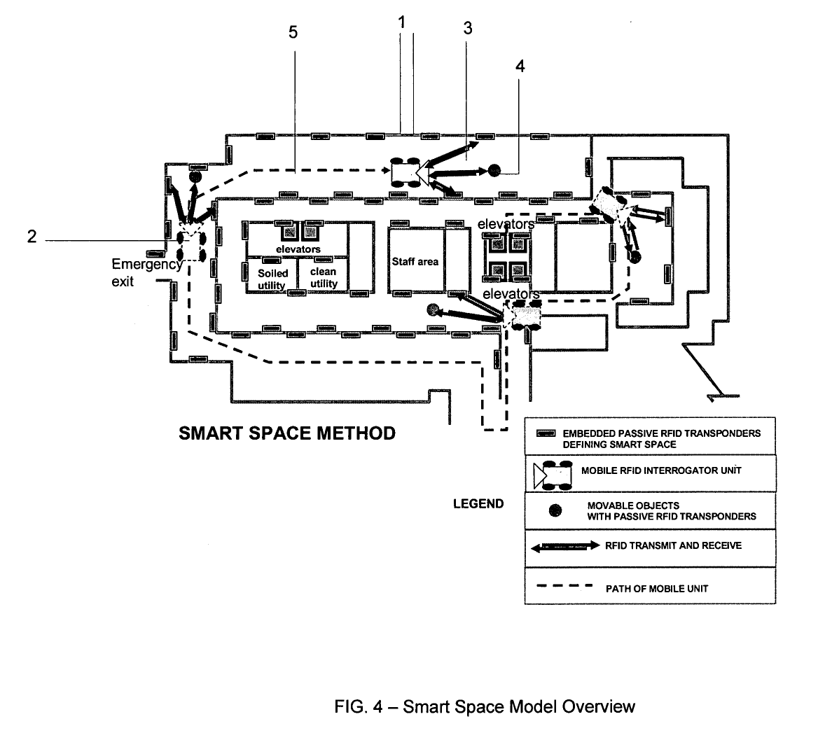

FIG. 4 provides an overview of the basic RFID system in one embodiment, which comprises a plurality of RFID tags attached to fixed locations in a finite space 1, a mobile RFID interrogator unit 2, and moveable objects 4 with attached RFID transponders. In the embodiment of FIG. 4, passive RFID transponders or tags 1 are embedded in the structural space of a hospital building. A mobile interrogator unit 2 traverses a path 5 through the building, periodically transmitting RF signals in order to detect RFID tags within its detection radius. The mobile interrogator unit 2 during one period of time transmits an RF signal 3 which is received by a tag 1 defining a fixed position in the building, causing the tag to transmit an RF signal back to the mobile interrogator unit 2 in a RF transmit and receive cycle 3. The mobile interrogator unit in this embodiment then performs a RF transmit and receive cycle 3 with respect to a moveable object 4 with an attached RFID tag. The system and method of this embodiment may then lookup the fixed position associated with the detected position tag 1 and infer that moveable object 4 is located near to the detected fixed position. In this manner an embodiment of the present invention can determine the location of a moveable object 4 in a structural space by utilizing a mobile interrogator unit 2.

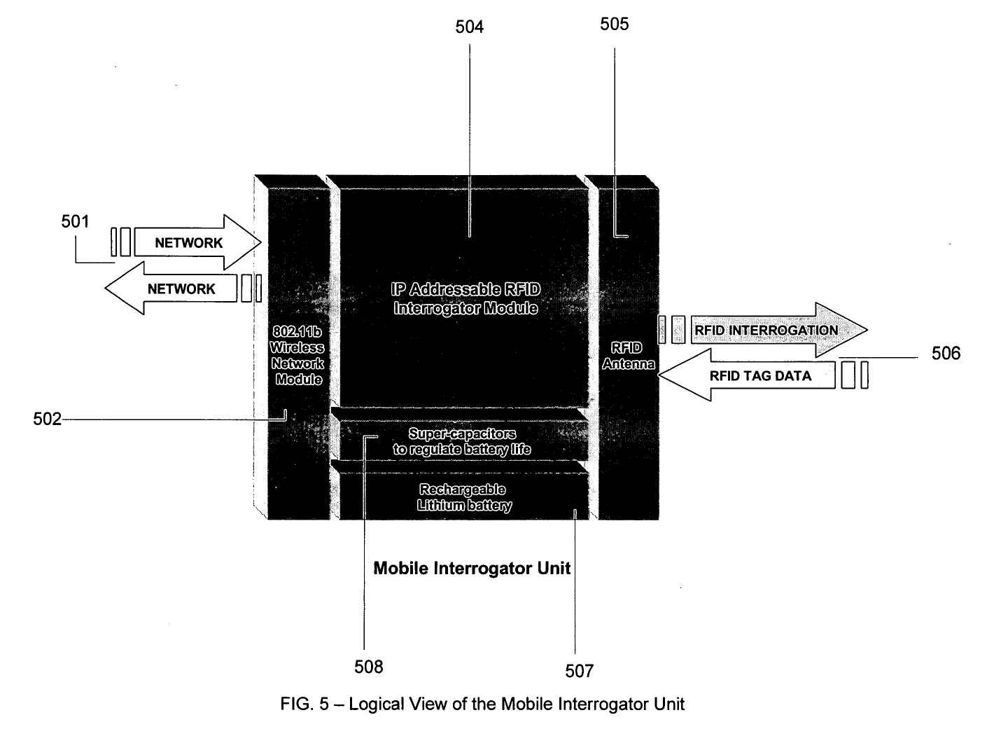

A logical overview of the mobile interrogator unit in one embodiment is illustrated in FIG. 5. In this embodiment, the mobile interrogator unit comprises logical functionality which provides a network interface 502, an interrogator module 504, RFID antenna 505, battery 507, and capacitors 508. In this embodiment, the network interface 502 is a 802.1 lb wireless network module. The antenna 505 is used to interrogate the surrounding space 506 for RFID tags and receive discovered RFID tag data. The IP addressable RFID interrogator module 504 allows the mobile interrogator to communicate tag data through the 802.1 lb wireless network module 502 across the network 501. Additionally, the mobile interrogator is powered by a rechargeable lithium battery 507 and utilizes super-capacitors 508 to regulate battery life.

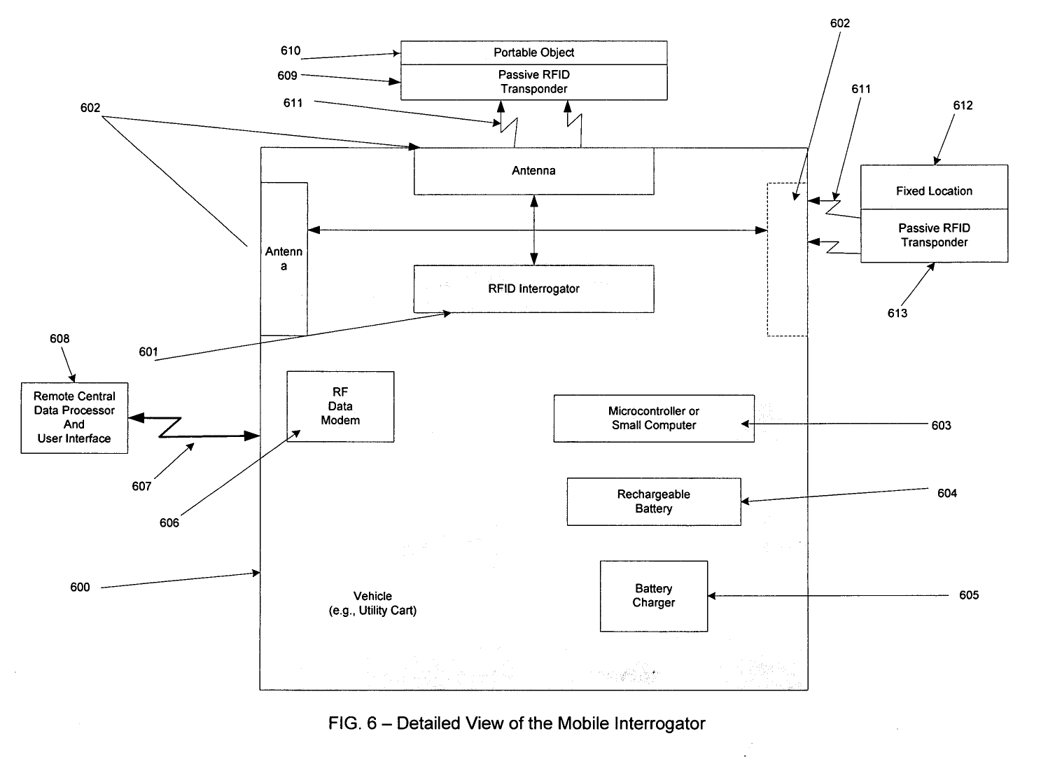

FIG. 6 illustrates another embodiment of the mobile interrogator, where the mobile interrogator is a vehicle-mounted RF transponder location system including a vehicle 600 (such as a utility cart or other mobile platform), on which is mounted an RF interrogator 601 connected to at least one antenna 602, a vehicle-mounted computer or microprocessor 603, a rechargeable battery 604, battery charger 605, and a radio frequency data modem 606 in radio frequency communication 607 with a remote central data processor and user interface 608. The vehicle-mounted RF reader/transponder location system's RFID interrogator 601, connected to a least one antenna 602, establishes radio frequency communication 611 with any RFID transponder 609 mounted to a portable object 610 that comes within range of at least one of the RFID interrogator's antennae 602. Likewise, the vehicle-mounted RF reader/transponder location system's RFID interrogator 601 establishes radio frequency communication 611 with a RFID transponder 613 mounted to a fixed location 612 that comes within range of at least one of the RFID interrogator's antennae 602.

The function of the transponder (609, 613) is to communicate data that identifies, directly or by means of a relational database, a portable object or fixed object. In one embodiment, the transponders (609, 613) are passive radio frequency identification (RFID) transponders, but may also be active RFID transponders. A passive transponder requires no battery and contains integrated non-volatile memory that allows data to be written to and read from individual tags. The transponder tag can be programmed with any type of data desired within the size constraint of the memory. This programming may be done in the field at installation or prior to installation. The description of the tagged portable object may include the nature of the equipment (or document) tagged, ownership, the responsible service provider, and other information. Thus, the transponder may be pre-programmed with information such as the standard Electronic Product Code (EPC) of the portable object 610 being tracked, description of the tagged object, maintenance dates, test results, and the like. Information pre-programmed into tags attached to fixed locations 612 may be the building floor and room number, or a designation relative to a 2-dimensional or 3-dimensional grid. The type of data stored in a tag is virtually unlimited. However, there are limitations on the transponder's memory capacity and storing detailed portable object records elsewhere in a relational database can supercede the extra processes and risks involved in frequently updating RFID transponder memory. It is expected that the memory capacity will increase as the technology matures; as such the scope of the present invention is intended to include such memory capacity increases. Although a one-time pre-programmed RFID transponder with relevant data programmed at installation may be utilized in various embodiments, it is not necessary to have any user programming performed for the system to work, as each transponder may be factory programmed with a unique identification (ID) number, which is all that is needed for positive detection and identification when the unique ID is associated with a record stored in a relational database resident in the vehicle-mounted computer 603 or transmitted 607 via the RF data modem 606 to a relational database resident in a remote central data processor 608.

Conditions that may adversely affect the detection range of the system include RF signal polarization, RF reflections, water, metal, contact surfaces, and shielding, each of which should be considered to ensure proper functioning of the system and method of the present invention. RF signal polarization should be considered and mitigated by correct tag and antenna orientation. Environments containing water will cause RF signal attenuation. For proper functioning, the RF tags should not be placed in direct contact with metal surfaces. Metal structures will shield the tags and impair detection. In one embodiment, tags should be located at least 21 millimeters in front of any metal surface or an object with respect to the antenna line-of-sight to achieve detection.

Other characteristics of the transponder that may affect the RFID transponder broadcast and response will include the minimum input power level for activation, the inherent delay of the transponder circuitry, temperature, humidity, RF interference, and other environmental conditions relative to the transponder. Characteristics of the vehicle-mounted components of the system that affect the RFID broadcast and response includes the interrogatory signal power level of the RFID interrogator 601, the signal power level of the transponder 609, the detection threshold of the RFID interrogator 601, and the gain of the antennae 602.

Because the transponder is a passive transponder in one embodiment, the lower the input energy required by it to generate a detectable response signal, the farther the detection range it will have. Therefore, it is desirable that the transponder operate at frequencies that are less susceptible to environmental interference and thus require less power to achieve a given range. The RFID frequency range of one embodiment may include frequencies from 125 KHz to 5 GHz, and those skilled in the art will also recognize that other frequencies or frequency ranges may be used with the present invention. Currently, the FCC has set aside a band of frequencies from 902-928 MHz for various purposes. The 915 MHz system according to one embodiment falls into the spread-spectrum application defined in Part 15 of the FCC regulations. The performance of the tags and the reader at approximately 915 MHz allows for relatively smaller antenna geometry and offsets the relative reduction in penetrating ability. The antenna 602 of one embodiment can be a single antenna or multiple antennae. In an embodiment using a single antenna, it can be a circularly polarized antenna, an omni-directional antenna, unidirectional antenna, or a directional antenna, such as a dipole antenna or Yagi antenna, for increased directionality and range.

The mobile or vehicle-mounted RFID transponder detection system interrogates the surrounding 3-dimensional space for tags a multiplicity of times per predetermined period. For one embodiment, the surrounding area or transponder vicinity is interrogated approximately 400 times per second. In one embodiment, the equipment reliably detects a passive RFID tag at a range of up to 10 feet.

The following scenario illustrates how the mobile interrogator of the embodiment depicted in FIG. 6 may be used to locate moveable objects in a finite space. In this scenario, locations described as ‘Central Distribution,’ ‘First Floor Elevator Door,’ ‘Sixth Floor Elevator Door,’ ‘Room 605,’ ‘Room 632,’ et cetera are speculative and are used for the sole purpose of describing one embodiment of the invention. The RFID interrogator vehicle's associated function is as a conveyance to transport and distribute portable objects to locations within the structural space. The portable objects are introduced into the system environment from a ‘Central Distribution’ point. The ‘Central Distribution’ area's walls, ceiling, or other fixed structures are affixed with location tags. The vehicle detects at least one of those tags to establish its present location and stores that data. At ‘Central Distribution’ tagged portable objects are placed on the vehicle, which immediately detects and identifies the object tags and generates a list of tagged objects that it associates with its present location at that time. As the vehicle is wheeled out of the ‘Central Distribution’ area with its cargo of portable objects, the ‘Central Distribution’ location tags are no longer detected, although the vehicle still detects the objects. Thereby the vehicle processor “reasons” that it has left the ‘Central Distribution’ area and is in transit with the cargo of portable objects. As the vehicle approaches the ‘First Floor Elevator Door’ it identifies a location tag and updates its list of objects as having been seen near the first floor elevator at that time. The vehicle is wheeled into the elevator and gets off on the sixth floor. As it passes through the ‘Sixth Floor Elevator Door’ the vehicle identifies the sixth floor elevator tag and updates its object list as being at the sixth floor elevator stop. On the sixth floor the vehicle identifies a tag as ‘Room 605.’ As the vehicle moves away from ‘Room 605,’ it detects that an object previously on the vehicle is no longer present. Because the vehicle last detected the object when it was at ‘Room 605,’ the vehicle processor and software “reasons” that the object was delivered to that location. As the vehicle continues along it briefly detects a tagged object that it passes in the hallway. That object is identified, time stamped, and added to the object list. As the vehicle passes the location tag at ‘Room 632’ it updates the record of the object that it passed in the hallway as located between ‘Room 605’ and ‘Room 632.’ Thus, while the RFID vehicle is used as a conveyance for the distribution of portable objects, it creates a continuously updated database that maps in real time the location of portable objects within the structural space.

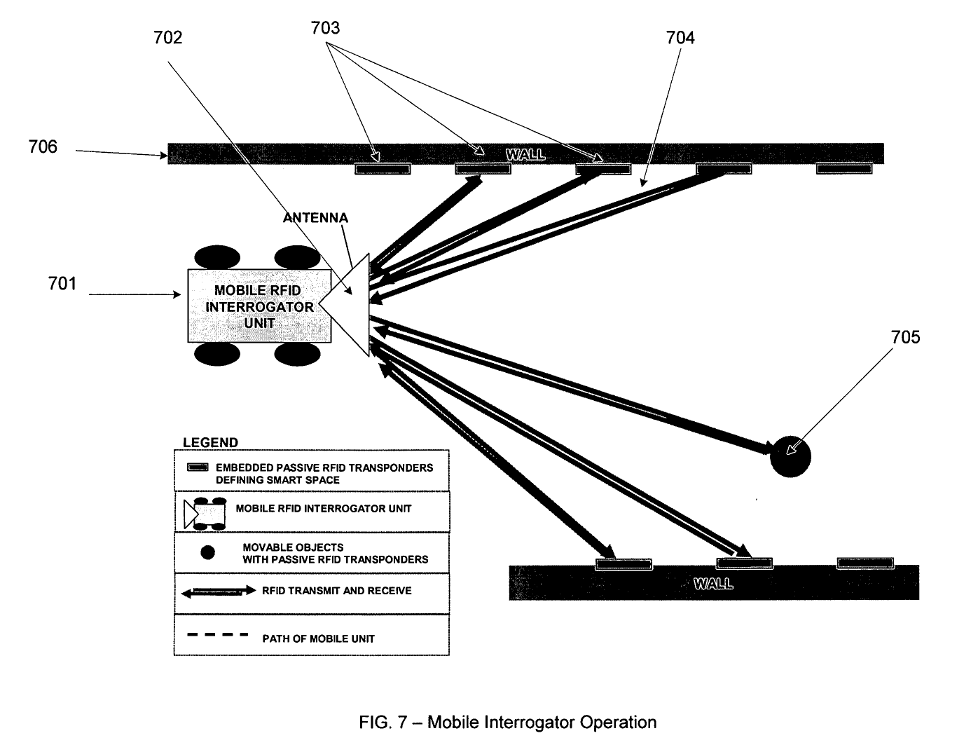

FIG. 7 illustrates one embodiment of a mobile interrogator 701 in operation. In this embodiment, the mobile interrogator 701 exists within a structural space which includes walls 706 with passive RFID tags attached at fixed positions 703. The mobile interrogator 701 locates tags by transmitting a modulated RF signal, causing tags within its broadcast proximity to receive the signal and transmit a RF signal back to the mobile interrogator in a transmit and receive cycle 704. The mobile interrogator 701 system can thereby determine that the moveable object 705 is near the location associated with the detected tags 703 in the structural space.

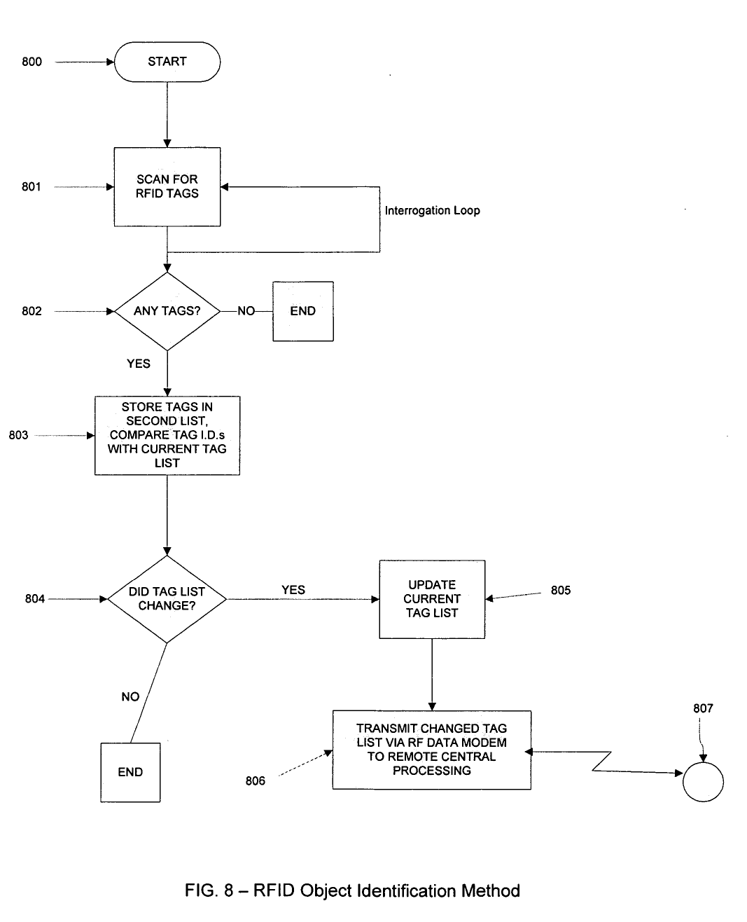

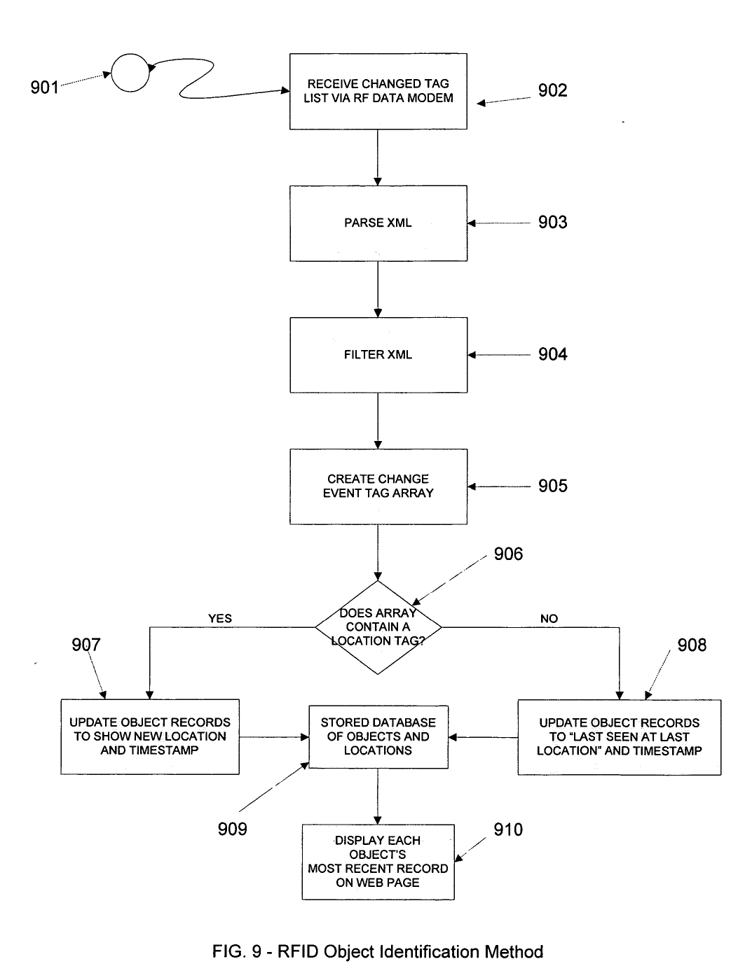

An illustration of one method used by the system and method of the present invention in one embodiment to locate RFID tagged moveable objects is depicted in FIG. 8 and FIG. 9. In the location method, an interrogator first scans for RFID tags 801 within proximity of the interrogator, with the interrogator maintaining a current list of tags within its proximity. The method then determines if any tags have been found 802. If no tags are found, the method ends. If one or more tag broadcast identifications are received, those tag identifiers are stored in a second tag list and those identifiers are compared 804 with the current tag list 803. If the second tag list is different from the current tag list, the current tag list is updated to reflect the second tag list 805, and the new current tag list is transmitted in the form of an Extensible Markup Language (XML) document to a remote central processor 806, which may be a server containing a network interface device and database software as understood in the art. The location method then proceeds to the steps of FIG. 9 at 807. Alternatively, if the current tag list and the second tag list are the same, then the method ends.

The method of identifying tagged portable objects continues in one embodiment as depicted by FIG. 9 at 901. The remote processor receives the changed tag list via a RF data modem 902. The remote processor then parses the XML document 903, filters the XML document 904, and creates a change event tag array 905 containing those RFID identifiers that were not present in the previously transmitted tag list. The method then determines if the array contains a location tag 906. If the array contains a location tag, the method updates object records to show a new location and time-stamp in the database of objects and records 909. If the array does not contain a location tag, the method updates the portable object's database records in the database of objects and locations 909 to reflect the object's last seen location and time-stamp 908. Finally, the identification and location method of this embodiment displays each portable object's most recent record on a web page viewable by a web browser such as Microsoft Internet Explorer.

The present invention has been illustrated in relation to embodiments which are intended in all respects to be illustrative rather than restrictive. Those skilled in the art will realize that the present invention is capable of many modifications and variations without departing from the scope of the invention.

1. A method for locating a moveable object, comprising the steps of:
a. placing a first RFID tag at a first fixed position, wherein the first RFID tag is adapted to broadcast a first identifier;
b. placing a second RFID tag on the moveable object, wherein the second RFID tag is adapted to broadcast a second identifier;
d. receiving the first identifier broadcast from the first RFID tag and the second identifier broadcast from the second RFID tag; and
e. identifying the location of the movable object as a function of its proximity to the first RFID tag.

2. The method of claim 1, wherein the first and second RFID tags are passive RFID tags.

3. The method of claim 1, further comprising the step of storing information associated with the first and second RFID tags in a storage device.

4. The method of claim 3, wherein the storage device comprises a database.

5. A method for locating a moveable object using a mobile interrogator, comprising the steps of:
a. placing a first RFID tag at a first fixed position, wherein the first RFID tag is adapted to broadcast a first identifier in response to an interrogation request;
b. placing a second RFID tag on the moveable object, wherein the second RFID tag is adapted to broadcast a second identifier in response to an interrogation request;
c. transmitting a first interrogation request from the mobile interrogator;
d. receiving the first identifier broadcast from the first RFID tag and the second identifier broadcast from the second RFID tag; and
e. identifying the location of the movable object as a function of its proximity to the first RFID tag.

6. The method of claim 5, further comprising the step of storing information associated with the first and second RFID tags in a storage device.

7. The method of claim 6, wherein the storage device comprises a database.

8. The method of claim 5, wherein the mobile interrogator comprises a battery and a processor.

9. The method of claim 8, wherein the mobile interrogator further comprises a network interface device.

10. A method for locating one or more moveable objects, comprising the steps of:
a. placing a RFID tag at one or more fixed positions, wherein each RFID tag is adapted to broadcast an identifier;
b. placing a RFID tag on one or more moveable objects, wherein each RFID tag is adapted to broadcast an identifier;
c. receiving at a first time RFID broadcasts identifying one or more RFID tags and storing the received identifiers in a first list;
d. receiving at a second time RFID broadcasts identifying one or more RFID tags and storing the received identifiers in a second list;
e. comparing the first and second lists to determine a difference; and
f. using the difference to determine the location of one or more moveable objects.

11. The method of claim 10, wherein the RFID tags are passive RFID tags.

12. The method of claim 10, wherein the steps of receiving RFID broadcasts at the first time and the second time are performed by a mobile interrogator.

13. The method of claim 12, wherein the mobile interrogator comprises a battery and a processor.

14. The method of claim 13, wherein the mobile interrogator further comprises a network interface device.

15. The method of claim 10, wherein the steps of storing the first list and the second list comprise storing the first list and the second list in a storage device.

16. The method of claim 15, wherein the storage device is a database.

17. A system for locating a moveable object, comprising:
a. a first RFID tag at a first fixed position, wherein the first RFID tag is adapted to broadcast a first identifier;
b. a second RFID tag on the moveable object, wherein the second RFID tag is adapted to broadcast a second identifier;
c. a receiver for receiving the first identifier broadcast from the first RFID tag and the second identifier broadcast from the second RFID tag; and
d. a processor for identifying the location of the movable object as a function of its proximity to the first RFID tag.

18. The system of claim 17, wherein the first and second RFID tags are passive RFID tags.

19. A device for locating a moveable object, wherein a first RFID tag is located at a first fixed position, the first RFID tag adapted to broadcast a first identifier, and wherein a second RFID tag is located on the moveable object, the second RFID tag adapted to broadcast a second identifier, the device comprising:
a. a receiver for receiving the first identifier broadcast from the first RFID tag and the second identifier broadcast from the second RFID tag; and
b. a processor for identifying the location of the movable object as a function of its proximity to the first RFID tag.

20. The system of claim 19, wherein the first and second RFID tags are passive RFID tags.
